(19) United States
(12) Patent Application Publication
(10) Pub. No.: US 2006/0152131 A1
(43) Pub. Date: Jul. 13, 2006

(54) Light source, fluorescent lamp and backlight module utilizing the same

(75) Inventors: Yi-Shiuan Tsai, Kaohsiung City (TW); Yi-Jing Wang, Hualien City (TW); Yi-Chun Lin, Hsinchu City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: AU Optronics Corp.

(21) Appl. No.: 11/142,652

(22) Filed: Jun. 1, 2005

(30) Foreign Application Priority Data
Jan. 13, 2005 (TW) 94100993

(51) Int. Cl. H01J 1/62

(52) U.S. Cl. 313/491

(57) ABSTRACT

Light source and backlight module utilizing the same. The light source includes a hollow glass tube and an electrode disposed therein. The electrode comprises a bent surface, increasing surface area, thereby increasing light emission efficiency and reducing temperature.

### BACKGROUND

The present invention is generally related to a backlight module, and more particularly, to a light source, a fluorescent lamp and a backlight module utilizing the same.

Currently, the main light source of a conventional backlight module is cold cathode fluorescent lamps (CCFLs). As shown in FIG. 1A, a conventional CCFL 10′ comprises a hollow glass tube 11′, electrodes 12a′ and 12b′, and wires 13a′ and 13b′. The electrodes 12a′ and 12b′ and the wires 13a′ and 13b′ are disposed at each end of the hollow glass tube 11′, respectively. The hollow glass tube 11′ contains mercury (Hg), phosphor, and inert gas (not shown). The electrodes 12a′ and 12b′ are cylindrical and made of metal. When a high voltage is applied to the electrode 12a′ of the hollow glass tube, electrons are emitted from the electrode 12b′ at low voltage end to the electrode 12a′ at high voltage end. The electrons are accelerated due to the high voltage, causing collisions with the Hg atoms in the hollow glass tube 11′. After collision with the Hg atoms, the Hg atoms quickly return to their stable state, and excess energy produces ultraviolet (UV) light. The UV light contacts or impacts the phosphors to produce visible light.

When the electrons are emitted from the low voltage end, and the gaseous ions collide at the electrode 12a′ at high voltage, however, a portion of gaseous ions 16′ are sputtered on the surface 15′ of the electrode 12a′, as shown in FIG. 1B. The sputtering area of gaseous ions 16 on the electrode surface 15′ is gradually increased with long-term use. When the surface 15′ is completely covered by the gaseous ions 16, it is the end of the lifetime of the lamp.

Thus, if gaseous ion sputtering time is shorter, the lifetime of the lam is longer. That is, if the surface of the electrode is larger, and sputtering area is increased, the temperature at the end of the electrode can be reduced accordingly.

Additionally, regarding of light emission efficiency of the lamp, the larger the surface area of the electrode for emitting electrons, the more electrons are released, producing higher intensity of UV light for better light emission efficiency.

In the conventional lamp, the length L′ of the electrode is increased to increase surface area for gaseous ion sputtering. As shown in FIG. 1A, however, although the surface area is increased, the total length and weight of the hollow glass tube are increased accordingly. Due to compact size demands, the conventional lamp is unsatisfactory. Moreover, if the length is increased, effective illumination region E′ is also reduced, and thus, light emission efficiency is still insufficient.

### SUMMARY

Embodiments of the present invention provide a light source to eliminate the shortcomings described by varying the shape of the electrode to increase surface area and light emission efficiency of the lamp while reducing electrode temperature.

Also provided is a light source comprising a hollow glass tube and an electrode disposed therein. The electrode comprises a bent surface.

The bent surface is substantially wave-shaped, substantially concavo-convex shaped, substantially bellow-shaped, substantially castellated-shaped, substantially ragged-shaped or substantially tooth-shaped.

The bent surface of the electrode comprises a plurality of connected protrusions, each of the connected protrusions comprising a tip-end.

In another embodiment, the bent surface of the electrode comprises a plurality of connected curved portions.

The electrode is substantially cup-shaped with a closed portion opposite to the central portion of the hollow glass tube. The light source further comprises a wire, electrically connected to the closed portion of the electrode and the hollow glass tube.

The cross-section of the electrode is substantially non-circular.

In an embodiment of the present invention, the light source further comprises a negative electrode having a bent surface, disposed opposing to the electrode.

The electrode is formed by metal-powder metallurgy or sheet-metal work.

Embodiments of the present invention further provide a backlight module, comprising a frame, a reflective sheet, and a lamp. The reflective sheet is disposed in the frame. The lamp is disposed over the reflective sheet, comprising a hollow glass tube and an electrode. The electrode is disposed in the hollow glass tube and comprises a bent surface. The backlight module further comprises at least one optical film, disposed over the lamp.

Embodiments of the present invention further provide a fluorescent lamp comprising a hollow glass tube, a first electrode, a second electrode, and two wires. The hollow glass tube comprises inert gas and mercury (Hg) therein. The first electrode is disposed at one end of the hollow glass tube, comprising a first bent surface. The second electrode is disposed at the other end of the hollow glass tube, comprising a second bent surface. The wires electrically connected to the hollow glass tube, the first electrode, and the second electrode, are disposed at each end of the hollow glass tube, respectively.

### BRIEF DESCRIPTION OF THE DRAWINGS

An exemplary embodiments of the present invention can be more fully understood by reading the subsequent detailed description in conjunction with the examples and references made to the accompanying drawings, wherein:

FIG. 1A is a cross-section of a conventional light source;

FIG. 1B is a local enlarged view of an electrode of a conventional light source;

FIG. 2 is a perspective view of a backlight module of an embodiment of the present invention;

FIG. 3A is a cross-section of a light source of an embodiment of the present invention;

FIG. 3B is a local enlarged view of a first electrode of a light source of an embodiment of the present invention;

FIG. 4A is a cross-section of a bent surface viewed from line AA′ of FIG. 3B;

FIG. 4B is a cross-section of another bent surface viewed from line AA′ of FIG. 3B;

FIG. 4C is a cross-section of yet another bent surface viewed from line AA′ of FIG. 3B.

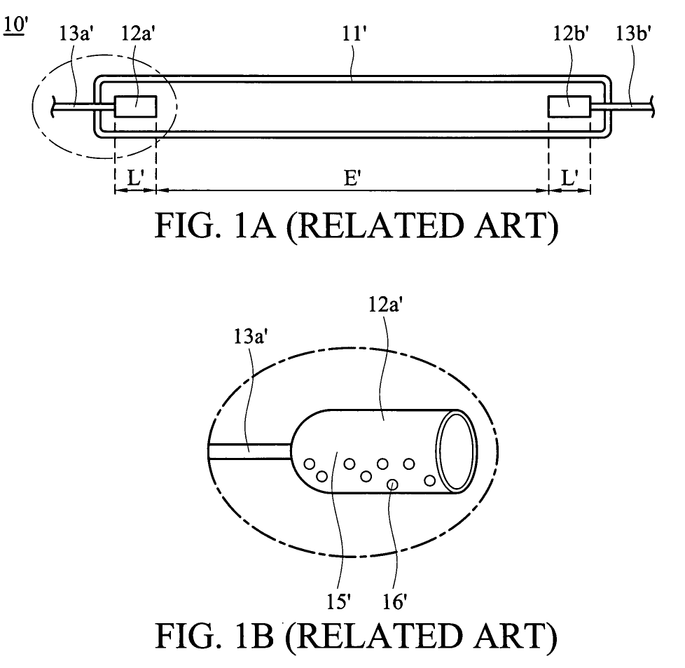

### DETAILED DESCRIPTION

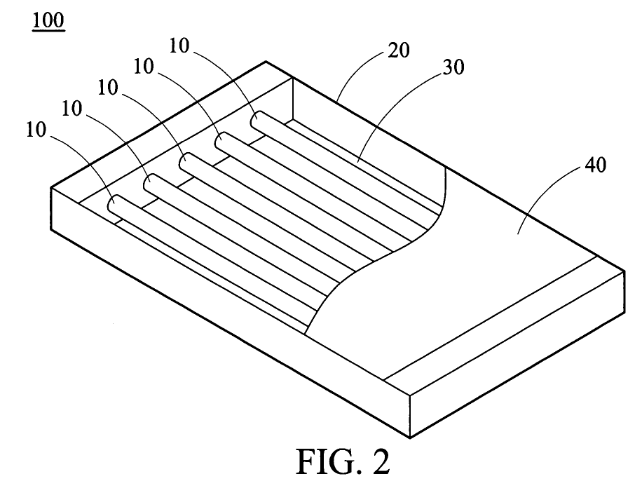

FIG. 2 is a perspective view of a backlight module 100 of an embodiment of the present invention. The backlight module 100 comprises a frame 20, a reflective sheet 30, a diffusion sheet 40, and a light source 10. The reflective sheet 30 is disposed in the frame 20. The backlight module 100 further comprises at least one optical film, disposed over the light source 10. The light source 10 is disposed over the reflective sheet 30. The light source 10 comprises a lamp such as a cold cathode fluorescent lamp. A principal aim of the present invention is to improve light emission efficiency of the backlight module 100, and thus, description of other elements in the backlight module is omitted.

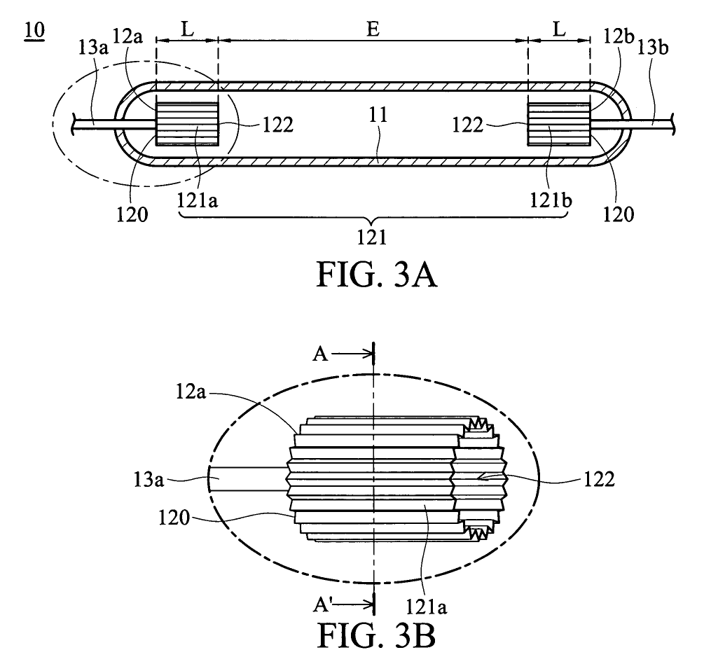

FIG. 3A is a cross-section of a light source 10 of an embodiment of the present invention. The light source comprises a hollow glass tube 11, a first electrode 12a, a second electrode 12b, and two wires 13a and 13b. The first electrode 12a is positive, and the second electrode 12b is negative. The electrodes 12a and 12b are disposed in the hollow glass tube at each end thereof, respectively. The first and second electrodes 12a and 12b comprise a first bent surface 121a and a second bent surface 121b, respectively. The wires 13a and 13b, electrically connected to the first electrode 12a and the second electrode 12b, are connected to each end of the hollow glass tube 11, respectively. The hollow glass tube 11 contains mercury (Hg), inert gas, and phosphor, disposed on an inner wall thereof. The inert gas comprises helium (He), neon (Ne), argon (Ar), krypton (Kr), xenon (Xe), radon (Rn), or a combination of at least two inert gases.

The negative electrode 12b is disposed at one end of the hollow glass tube 11. Electrons emitted from the bent surface 121b and accelerated due to high voltage, collide with the ions of inert gas and mercury atoms in the hollow glass tube 11, thereby producing UV light. The positive electrode 12a is disposed at the other end of the hollow glass tube 11. A portion of gaseous ions are sputtered on the bent surface 121a.

FIG. 3B is a local enlarged view of the first electrode 12a of the light source 10 of an embodiment of the present invention. As shown in FIGS. 3A and 3B, the first electrode 12a is substantially cup-shaped, comprising an opening portion 122 and a closed portion 120. The bent surface 121a is connected to the closed portion 120, and the opening portion 122 faces to a central portion of the hollow glass tube 11.

The first electrode 12a and the second electrode 12b can be formed by metal-powder metallurgy or sheet-metal work. Thus, manufacturing costs are reduced. By modifying the shape of the electrodes, the electrode is not lengthened, and can moreover, is shortened while providing greater effective light emission region E.

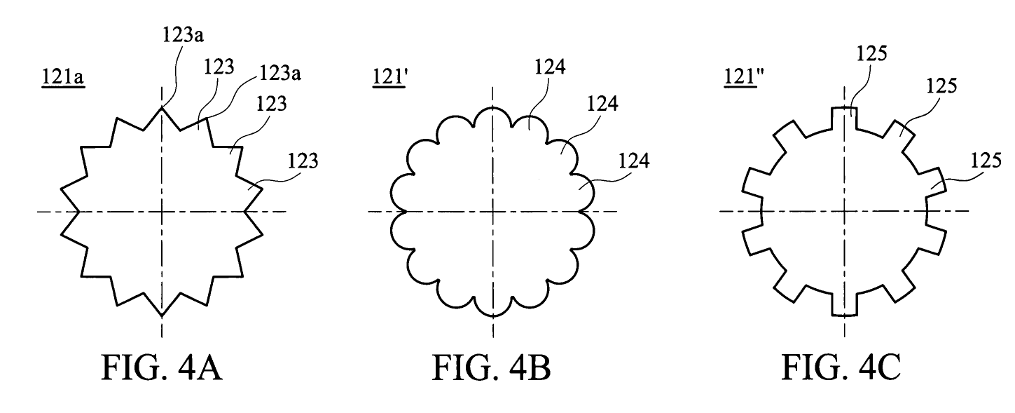

In detail, for example, the bent surface 121a of the first electrode 12a is substantially castellated-shaped or substantially ragged-shaped. FIG. 4A is a cross-section of a bent surface 121a of the first electrode 12a viewed from line AA′ of FIG. 3B. The bent surface 121a of the first electrode 12a comprises a plurality of connected protrusions 123, each of the connected protrusions comprising a tip-end 123a. That is, the cross-section of the first electrode 12a is substantially non-circular.

The present invention is not limited to the above example. In some embodiments, only the negative electrode 12b has a bent surface 121b, and the positive electrode 12a has smooth surface. As long as one of the electrodes has a bent surface, since the area of the electron-emitting end is increased, the electrode can release more electrons such that more UV light is produced. Thus, light emission efficiency is improved. Alternatively, if only the positive electrode 12a has a bent surface 121a, since the surface area is also increased, sputtering area is increased, and thus, the sputtering time is longer. The lifetime of the light source is extended, and temperature of the electrode is reduced accordingly.

The present invention further has variations. In some embodiments of the present invention, as shown in FIG. 4B, the bent surface 121′ can be substantially wave-shaped or substantially concavo-convex-shaped, and comprise a plurality of connected curved portions 124.

In another variation of the present invention, as shown in FIG. 4C, the bent surface 121″ is substantially bellow-shaped or substantially tooth-shaped, and comprises a plurality of connected protrusions 125.

Hence, by varying the shape of the electrode, the surface area of the electrode is increased radially, and light emission efficiency of the lamp is increased accordingly, while reducing electrode temperature and increasing lifetime of the lamp and electrodes.

While the present invention has been described by way of example and in terms of preferred embodiment, it is to be understood that the present invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A light source, comprising:
a hollow glass tube; and
an electrode having a bent surface, disposed at one end of the hollow glass tube.

2. The light source of claim 1, wherein the bent surface of the electrode is substantially wave-shaped, substantially concavo-convex shaped, substantially bellow-shaped, substantially castellated-shaped, substantially ragged-shaped, or substantially tooth-shaped.

3. The light source of claim 1, wherein the bent surface of the electrode comprises a plurality of connected protrusions, each of the connected protrusions comprising a tip-end.

4. The light source of claim 1, wherein the bent surface of the electrode comprises a plurality of connected curved portions.

5. The light source of claim 1, wherein the electrode is substantially cup-shaped with a closed portion opposite to the central portion of the hollow glass tube.

6. The light source of claim 5, further comprising a wire electrically connected to the closed portion of the electrode and the hollow glass tube.

7. The light source of claim 1, wherein the cross-section of the electrode is substantially non-circular.

8. The light source of claim 1, further comprising a negative electrode having a bent surface, disposed opposing to the electrode.

9. The light source of claim 1, wherein the electrode is formed by metal-powder metallurgy or sheet-metal work.

10. A backlight module, comprising:
a frame;
a reflective sheet disposed in the frame; and
a lamp, disposed over the reflective sheet, comprising:
a hollow glass tube; and
an electrode having a bent surface, disposed at one end of the hollow glass tube.

11. The backlight module of claim 10, wherein the bent surface of electrode is substantially wave-shaped, substantially concavo-convex shaped, substantially bellow-shaped, substantially castellated-shaped, substantially ragged-shaped, or substantially tooth-shaped.

12. The backlight module of claim 10, further comprising at least one optical film disposed over the lamp.

13. The backlight module of claim 10, wherein the bent surface of the electrode comprises a plurality of connected protrusions, each of the connected protrusions comprising a tip-end.

14. The backlight module of claim 10, wherein the bent surface of the electrode comprises a plurality of connected curved portions.

15. The backlight module of claim 10, wherein the electrode is substantially cup-shaped with a closed portion opposite to a central portion of the hollow glass tube.

16. The backlight module of claim 15, wherein the lamp further comprises a wire electrically connected to the closed portion of the electrode and the hollow glass tube.

17. The backlight module of claim 10, wherein the cross-section of the electrode is substantially non-circular.

18. The backlight module of claim 10, further comprising a negative electrode having a bent surface, disposed opposing to the electrode.

19. A fluorescent lamp, comprising:
a hollow glass tube comprising an inert gas and a mercury therein;
a first electrode comprising a first bent surface, disposed at one end of the hollow glass tube;
a second electrode comprising a second bent surface, disposed at the other end of the hollow glass tube; and
two wires disposed at each end of the hollow glass tube, respectively, electrically connected to the hollow glass tube, the first electrode and the second electrode.

20. The fluorescent lamp of claim 19, wherein the hollow glass tube comprises phosphor disposed on the inner wall of the hollow glass.

21. The fluorescent lamp of claim 19, wherein the first bent surface and the second bent surface are substantially wave-shaped, substantially concavo-convex shaped, substantially bellow-shaped, substantially castellated-shaped, substantially ragged-shaped, or substantially tooth-shaped, respectively.

22. The fluorescent lamp of claim 19, wherein the first bent surface and the second bent surface comprises a plurality of connected protrusions, each of the connected protrusions comprising a tip-end.

23. The fluorescent lamp of claim 19, wherein the first bent surface and the second bent surface comprises a plurality of curved portions.

24. The fluorescent lamp of claim 19, wherein the cross-sections of the first electrode and the second electrode are substantially non-circular.
